(19) United States
(12) Patent Application Publication
(10) Pub. No.: US 2013/0159389 A1
(43) Pub. Date: Jun. 20, 2013

(54) Utilizing Dynamic Heuristic Transitions between Local and Remote Data for Displaying Electronic Communications

(71) Applicants: Justin Bradley Mahood, Redmond, WA (US); Keshav S. Rajan, Bellevue, WA (US); Saurabh Kumar, Bellevue, WA (US); Andrew John Sullivan, Seattle, WA (US); Ryan Edward Gregg, Seattle, WA (US); Bruce D. Wiedemann, Kirkland, WA (US); Robert R. Novitskey, Redmond, WA (US)

(72) Inventors: Justin Bradley Mahood, Redmond, WA (US); Keshav S. Rajan, Bellevue, WA (US); Saurabh Kumar, Bellevue, WA (US); Andrew John Sullivan, Seattle, WA (US); Ryan Edward Gregg, Seattle, WA (US); Bruce D. Wiedemann, Kirkland, WA (US); Robert R. Novitskey, Redmond, WA (US)

(73) Assignee: MICROSOFT CORPORATION, Redmond, WA (US)

(21) Appl. No.: 13/330,032

(22) Filed: Dec. 19, 2011

(51) Int. Cl. G06F 15/16

(52) U.S. Cl. 709/203

(57) ABSTRACT

Utilizing dynamic heuristic transitions between local and remote data for displaying electronic communications is provided. A computer may load one or more folders associated with the electronic communications. The computer may then determine an initial mode for viewing the electronic communications. The computer may then display the remote data upon determining that the initial mode for viewing the electronic communications is an online mode or display the local data upon determining that the initial mode is offline. The computer may then synchronize local data and the remote data to update the local data. The computer may then automatically transition from displaying the remote data to displaying the local data after the update of the local data. The computer may also automatically transition from displaying the local data to displaying the remote data after determining that the local data is out of date.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Many electronic communications applications offer local e-mail synchronization which provides users offline access to data (e.g., e-mail) when they are not connected to the Internet or a network. Previous e-mail synchronization methods however, suffer from a number of drawbacks. For example, one drawback associated with previous methods is that data access was either primarily offline with automatic synchronization (e.g., “cached” mode) or “online-only.” Problems associated with these methods include users only being allowed to manually synchronize certain components of data for offline use (i.e., user-initiated caching of data). As a result, offline data was only displayed to the user in the absence of a network connection and, in addition, during offline use, data the user had not previously looked at was not available for viewing. Another drawback is associated with methods that utilize a “header mode” which enables users to download a small subset of online data for offline viewing. The online data subset may include an e-mail message list displaying part of a message. A user may then click on a listed message to retrieve the rest of the message from the network. However, “header mode” viewing also requires manual intervention by a user to view data offline. It is with respect to these considerations and others that the various embodiments described herein have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for utilizing dynamic heuristic transitions between local and remote data for displaying electronic communications is provided. A computer may load one or more folders associated with the electronic communications. The computer may then determine an initial mode for viewing the electronic communications. The computer may then display the remote data upon determining that the initial mode for viewing the electronic communications is an online mode. The computer may then synchronize local data with the remote data to update the local data. The computer may then automatically transition from displaying the remote data to displaying the local data after the update of the local data.

These and other features and advantages will be apparent from a reading of the following detailed description and a review of the associated drawings. It is to be understood that both the foregoing general description and the following detailed description are illustrative only and are not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 shows a network architecture for utilizing dynamic heuristic transitions between local and remote data for displaying electronic communications, in accordance with an embodiment;

FIG. 2 is a block diagram showing contents of the local and remote data of FIG. 1, in accordance with an embodiment;

FIG. 3 is a flow diagram illustrating a routine for utilizing dynamic heuristic transitions between local and remote data for displaying electronic communications, in accordance with an embodiment;

FIG. 4 is a flow diagram illustrating a routine for utilizing dynamic heuristic transitions between local and remote data for displaying electronic communications, in accordance with another embodiment;

FIG. 5 is a simplified block diagram of a computing device with which various embodiments may be practiced;

FIG. 6A is a simplified block diagram of a mobile computing device with which various embodiments may be practiced; and

FIG. 6B is a simplified block diagram of a mobile computing device with which various embodiments may be practiced.

### DETAILED DESCRIPTION

Embodiments are provided for utilizing dynamic heuristic transitions between local and remote data for displaying electronic communications is provided. A computer may load one or more folders associated with the electronic communications. The computer may then determine an initial mode for viewing the electronic communications. The computer may then display the remote data upon determining that the initial mode for viewing the electronic communications is an online mode. The computer may then synchronize local data with the remote data to update the local data. The computer may then automatically transition from displaying the remote data to displaying the local data after the update of the local data.

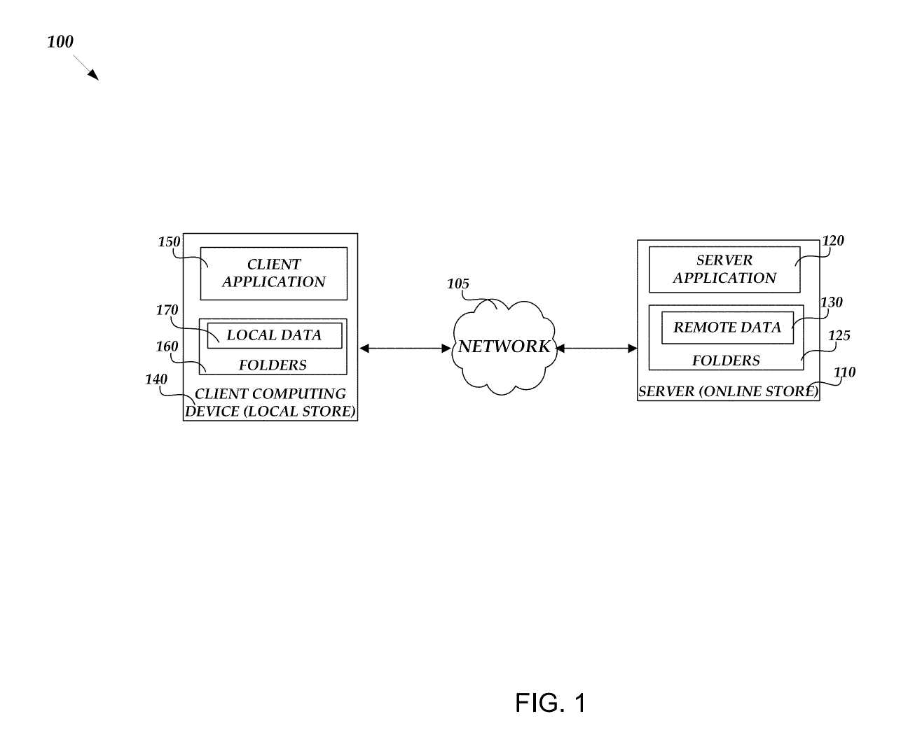

FIG. 1 shows a network architecture 100 for utilizing dynamic heuristic transitions between local and remote data for displaying electronic communications, in accordance with an embodiment. The network architecture 100 includes a server 110 (i.e., an online store) which is in communication with a client computing device 140 (i.e., a local store) over a network 105. It should be appreciated that the network 105 may comprise a distributed computing network (e.g., the Internet or a wireless network).

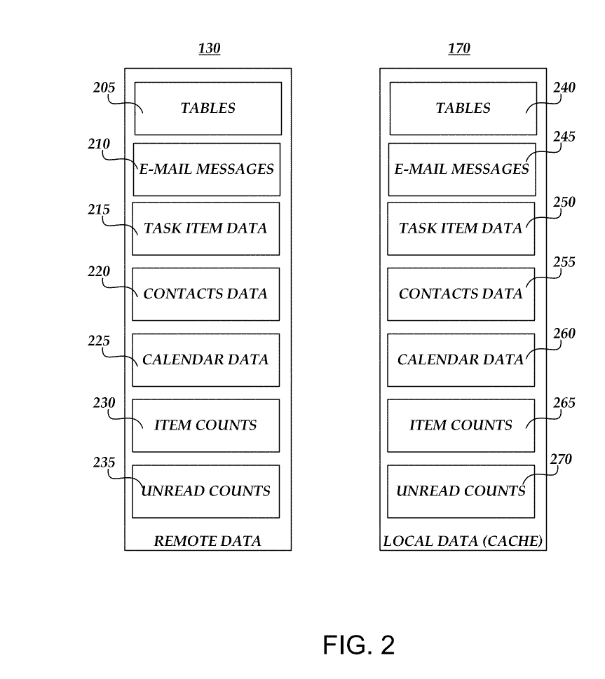

The server 110 may include a server application 120 and folders 125. The server application 120 may be configured to provide electronic communications (e.g., electronic mail, calendaring, contacts and tasks) to the client computing device 140 over the network 105. In accordance with an embodiment, the server application 120 may comprise the EXCHANGE SERVER collaborative application software from MICROSOFT CORPORATION of Redmond, Wash. It should be understood, however, that other collaborative application software from other manufacturers may be utilized in accordance with the various embodiments described herein. The folders 125 may comprise constructs for organizing electronic communications (e.g., e-mails) into categories such as “Inbox,” “Sent Items, “Deleted Items,” etc., which are stored on the server 110. It should be appreciated that the aforementioned electronic communications may also include calendars and contacts as well. Furthermore, each of the folders 125 may contain remote data 130. As will be described in greater detail below with respect to FIG. 2, the remote data 130 may comprise tables, electronic mail messages, task item data, contacts data, calendar data, item counts and unread counts associated with the electronic communications provided by the server application 120 on the server 110. It should be understood that the remote data 130 includes online data which may be synchronized (i.e., “synced”) with local data stored on the client computing device 140.

The client computing device may include a client application 150 and folders 160. The client application 150 may be configured to view electronic communications (e.g., electronic mail, calendaring, contacts and tasks) provided by the server application 120 over the network 105. In accordance with an embodiment, the client application 150 may comprise a personal information management software application such as the OUTLOOK personal information management software from MICROSOFT CORPORATION of Redmond Wash. It should be understood, however, that communication software applications as well as other personal information management software applications from other manufacturers also may be utilized in accordance with the various embodiments described herein. It should further be appreciated that the aforementioned personal information management software may comprise an individual application program or alternatively, may be incorporated into a suite of productivity applications such as the OFFICE application program suite from MICROSOFT CORPORATION. The folders 160 may comprise constructs for organizing electronic communications (e.g., e-mails) into categories such as “Inbox,” “Sent Items, “Deleted Items,” etc. which are stored on the client computing device 140. It should be appreciated that the aforementioned electronic communications may also include calendars and contacts as well. Furthermore, each of the folders 160 may contain local data 170. As will be described in greater detail below with respect to FIG. 2, the local data 170 may comprise tables, electronic mail messages, task item data, contacts data, calendar data, item counts and unread counts associated with the electronic communications provided by the server application 120. It should be understood that the local data 170 includes cached data which may be synchronized (i.e., “synced”) with the remote data 130 stored on the server 110.

FIG. 2 is a block diagram showing contents of the local and remote data of FIG. 1, in accordance with an embodiment. The remote data 130 may comprise tables 205, e-mail messages 210, task item data 215, contacts data 220, calendar data 225, item counts 230 and unread counts 235, which are stored on the server 110 (i.e., online).

Similarly, the local data 170 may comprise tables 240, e-mail messages 245, task item data 250, contacts data 255, calendar data 260, item counts 265 and unread counts 270, which are stored on the client computing device 140 (i.e., cached). It should be understood however, that in accordance with the various embodiments discussed herein, the remote data 130 and the local data 170 may include any form of electronic communication and thus are not limited to the aforementioned specified types of data. In accordance with an embodiment, the tables 205 and 240 may comprise database tables which are populated with the data required to display a list of e-mail messages (such as the e-mail messages 210 and 245) as well as task items, contacts, calendars, item counts and unread counts which may be viewed in the client application 150.

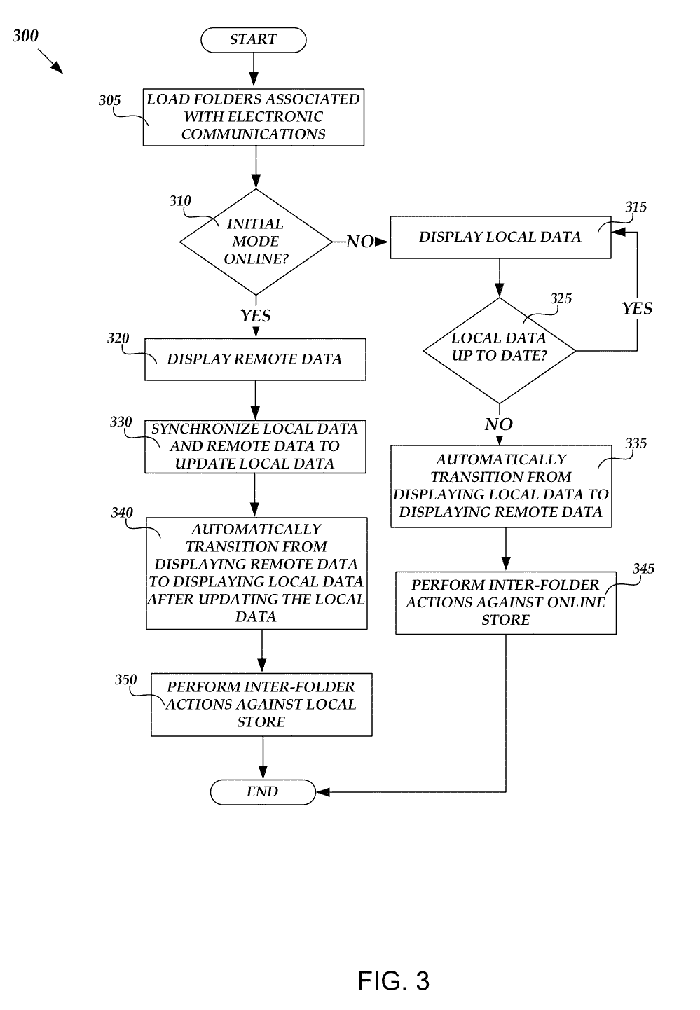

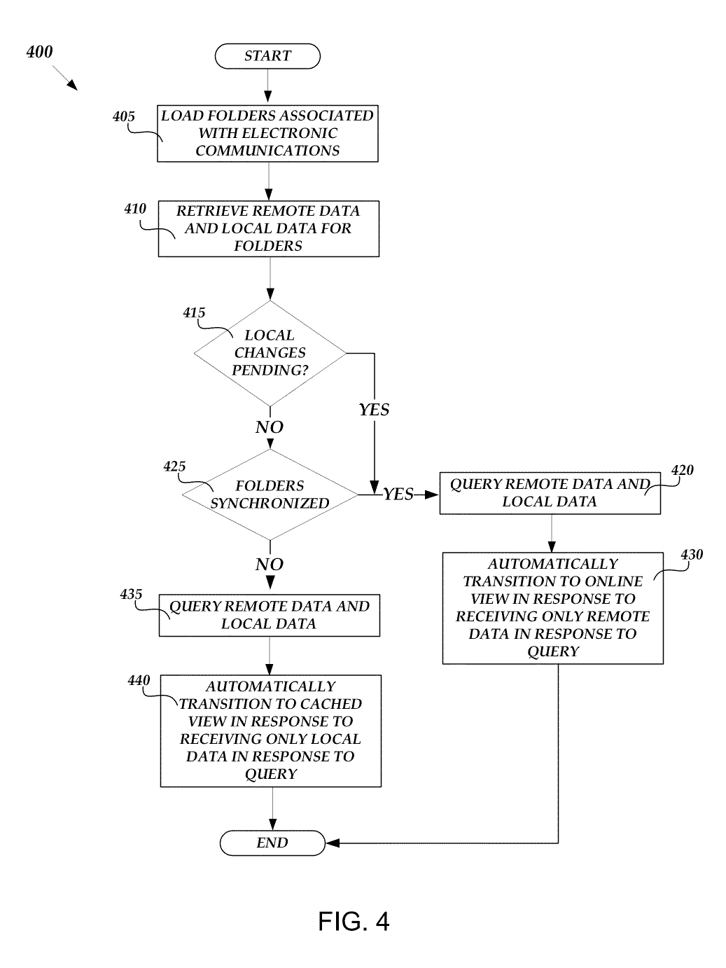

FIG. 3 is a flow diagram illustrating a routine 300 for utilizing dynamic heuristic transitions between local and remote data for displaying electronic communications, in accordance with an embodiment. When reading the discussion of the routines presented herein, it should be appreciated that the logical operations of various embodiments are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the various embodiments. Accordingly, the logical operations illustrated in FIGS. 3-4 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the various embodiments as recited within the claims set forth herein.

The routine 300 begins at operation 305, where the client application 150 executing on the client computing device 140 (discussed above with respect to FIG. 1) may load one or more folders associated with electronic communications. For example, a user of the client application 150 may load an Inbox folder from the folders 125 on the server 110 and load an Inbox folder from the folders 160 on the client computing device 140, after starting (e.g., “booting”) the client computing device 140 or by switching from viewing another folder in the client application 150 (i.e., by clicking on the Inbox folder).

From operation 305, the routine 300 continues to operation 310, where the client application 150 executing on the client computing device 140 may determine an initial mode for viewing electronic communications on the client computing device 140. It should be understood that, in accordance with the various embodiments discussed herein, a “mode” is an origin store from which the data (i.e., the electronic communications) is sourced. For example, the client application 150 may determine whether a server network connection, for providing one or more of the folders 125 to the client computing device 140, is either online (i.e., online mode) or offline (i.e., cached mode). In accordance with an embodiment, the aforementioned determination may be made based on a number of initial conditions to determine an optimal “mode” of operation including, but not limited to, synchronization state, network latency and network bandwidth. If, at operation 310, it is determined that the network connection is offline, then the routine 300 continues to operation 315. If, at operation 310, it is determined that the network connection is online, then the routine 300 branches to operation 320.

At operation 315, the client application 150 executing on the client computing device 140 may display local data associated with one or more of the folders loaded at operation 305. For example, the client application 150 may display a list of e-mail messages retrieved from the local data 170 (i.e., cached data) stored on the client computing device 140.

From operation 315, the routine 300 branches to operation 325, where the client application 150 executing on the client computing device 140 may determine whether the local data displayed at operation 315 is up to date with the server 110. For example, the client application 150 may synchronize the local data 170 with the remote data 130 on the server 110 to determine if the local data 170 is up to date with the remote data 130 on the server 110 after the network connection to the server 110 has been restored. If, at operation 325, it is determined that the local data 170 is up to date, then the routine 300 returns to operation 315 where the client application 150 continues to display the local data 170 on the client computing device 140. If, at operation 325, it is determined that the local data is not up to date, then the routine 300 branches to operation 335.

At operation 335, the client application 150 executing on the client computing device 140 may automatically transition from displaying the local data 170 to displaying the remote data 130 on the client computing device. In particular, the client application 150 may automatically transition from displaying the local data 170 to displaying the remote data 130 after restoration of the network connection to the server 110 for providing one or more of the folders 125 to the client computing device 140.

From operation 335, the routine 300 branches to optional operation 345, where the client application 150 executing on the client computing device 140 may perform an inter-folder action against the server 110 (i.e., the online store) when displaying an item in the remote data 130. In accordance with an embodiment, inter-folder actions may include actions which modify the contents of one or more of the folders 125 on the sever 110. For example, inter-folder actions may include, but are not limited to, copying and moving items between folders (e.g., copying e-mail messages from an Inbox folder to a Sent Items folder) and deleting items from a folder. It should be understood that the aforementioned copy, move and delete actions may be accomplished via dragging and dropping items between folders or via keyboard shortcuts (e.g., Ctrl-C/Ctrl-V for copy/paste actions and Ctrl-X for delete actions) on the client computing device 140. From operation 345, the routine 300 then ends.

Returning now to the “Yes” branch of operation 310, the routine 300 continues at operation 320, where the client application 150 executing on the client computing device 140 may display remote data associated with one or more of the folders loaded at operation 305. For example, the client application 150 may display a list of e-mail messages retrieved from the remote data 130 (i.e., online data) stored on the server 110.

From operation 320 the routine 300 branches to operation 330, where the client application 150 executing on the client computing device 140 may synchronize the local data and the remote data to update the local data. For example, the client computing device 140 may synchronize the local data 170 with the remote data 130 on the server 110 to ensure that the tables, e-mail messages, task item data, contacts data, calendar data, item counts and unread counts in the local data 170 (i.e., the cache) are the most recent versions of the aforementioned items.

From operation 330, the routine 300 branches to operation 340, where the client application 150 executing on the client computing device 140 may automatically transition from displaying the remote data 130 to displaying the local data 170 on the client computing device. For example, in accordance with an embodiment, the client application 150 may automatically transition from displaying one or more of the online tables 205 in the remote data 130 to displaying one or more of the cached tables 240 in the local data 170. In accordance with another embodiment, the client application 150 may automatically transition from displaying one or more of the online item and online unread counts in the remote data 130 to displaying one or more of the cached item and cached unread counts in the local data 170.

From operation 340, the routine 300 branches to optional operation 350, where the client application 150 may perform an inter-folder action against the client computing device 140 (i.e., the local store) when displaying an item in the local data 170. In accordance with an embodiment, inter-folder actions may include actions which modify the contents of one or more of the folders 160 on the client computing device 140. For example, inter-folder actions may include, but are not limited to, copying and moving items between folders (e.g., copying e-mail messages from an Inbox folder to a Sent Items folder) and deleting items from a folder. It should be understood that the aforementioned copy, move and delete actions may be accomplished via a command invocation, dragging and dropping items between folders or via keyboard shortcuts (e.g., Ctrl-C/Ctrl-V for copy/paste actions and Ctrl-X for delete actions) on the client computing device 140. From operation 350, the routine 300 then ends. It should be understood that, in accordance with an embodiment, the inter-folder actions described in operations 345 and 350 may be performed independently of the displaying of local and remote data described above in operations 305-340.

FIG. 4 is a flow diagram illustrating a routine 400 for utilizing dynamic heuristic transitions between local and remote data for displaying electronic communications, in accordance with another embodiment. The routine 400 begins at operation 405, where the client application 150 executing on the client computing device 140 (discussed above with respect to FIG. 1) may load one or more folders associated with electronic communications. For example, a user of the client application 150 may load an Inbox folder from the folders 125 on the server 110 and load an Inbox folder from the folders 160 on the client computing device 140, after booting the client computing device 140 or by switching from viewing another folder in the client application 150 (i.e., by clicking on the Inbox folder).

From operation 405, the routine 400 continues to operation 410, where the client application 150 executing on the client computing device 140 may retrieve remote data and local data for the one or more folders loaded at operation 405. In particular, the client application 150 may retrieve the remote data 130 from the server 110 and the local data 170 from the client computing device 140. For example, in accordance with an embodiment, the client application 150 may retrieve one or more of the tables 205 and 240 utilized for displaying a list of e-mail messages and/or displaying item and unread counts associated with the displaying the list of e-mail messages, on the client computing device 140.

From operation 405, the routine 400 continues to operation 410, where the client application 150 executing on the client computing device 140 may determine whether local changes are pending for the one or more folders loaded at operation 405. For example, the client application 150 may determine whether there are changes in the local data 170 awaiting synchronization with the server 110 (i.e., the online store). If, at operation 410, it is determined that local changes are pending, then the routine 400 continues to operation 420. If, at operation 410, it is determined that local changes are not pending, then the routine 400 branches to operation 425.

At operation 420, the client application 150 executing on the client computing device 140 may query the remote data and the local data for the one or more folders loaded at operation 405. For example, the client application 150 may query one or more of the online tables 205 in the remote data 130 and one or more of the cached tables 240 in the local data 170.

From operation 420, the routine 400 branches to operation 430, where the client application 150 executing on the client computing device 140 may automatically transition to a cached view of the data in the one or more folders loaded at operation 405 in response to receiving only local data in response to the query made at operation 420. In particular, the client application 150 may transition to the cached view upon determining that a timeout has passed for receiving the remote data 130 from the server 110. It should be understood that in accordance with this embodiment, the initial view for viewing the data is an online view. From operation 430, the routine 400 then ends.

Returning now to the “No” branch of operation 415, the routine 400 continues at operation 425, where the client application 150 executing on the client computing device 140 may determine whether or not the or more folders loaded at operation 405 are synchronized. In particular, the client application 150 may determine if the server is up to date (i.e., the remote data 130 on the server 110 is up to date with the local data 170 on the client computing device 140). If, at operation 425, it is determined that the folders are synchronized, then the routine 400 returns to operation 420 (discussed above). If, at operation 410, it is determined that folders are not synchronized, then the routine 400 branches to operation 435.

At operation 435, the client application 150 executing on the client computing device 140 may query the remote data and the local data for the one or more folders loaded at operation 405. For example, the client application 150 may query one or more of the online tables 205 in the remote data 130 and one or more of the cached tables 240 in the local data 170.

From operation 435, the routine 400 continues to operation 440, where the client application 150 executing on the client computing device 140 may automatically transition to an online view of the data in the one or more folders loaded at operation 405 in response to receiving only remote data in response to the query made at operation 435. In particular, the client application 150 may transition to the online view upon determining that a timeout has passed for receiving the local data 170 from the client computing device 140. It should be understood that in accordance with this embodiment, the initial view for viewing the data is a cached view. From operation 440, the routine 400 then ends.

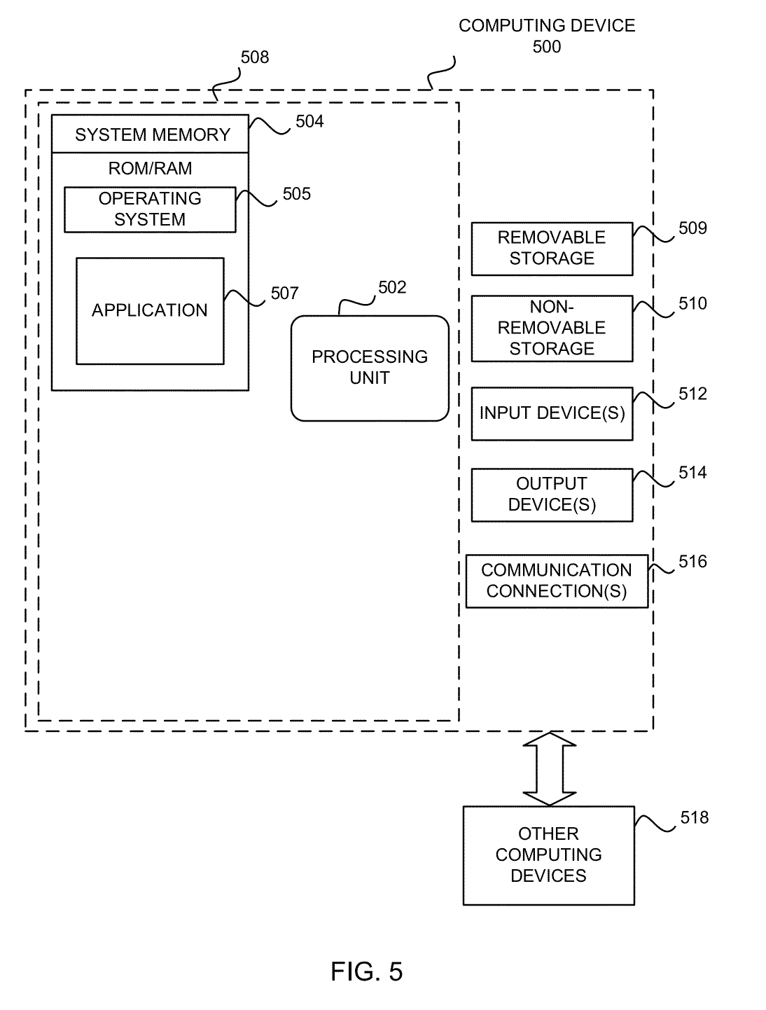

FIG. 5 is a block diagram illustrating example physical components of a computing device 500 with which various embodiments may be practiced. The computing device components described below may be suitable for the client computing device 130 or the server 110 described above with respect to FIG. 1. In a basic configuration, the computing device 500 may include at least one processing unit 502 and a system memory 504. Depending on the configuration and type of computing device, system memory 404 may comprise, but is not limited to, volatile (e.g. random access memory (RAM)), non-volatile (e.g. read-only memory (ROM)), flash memory, or any combination. System memory 504 may include an operating system 505 and applications 507. Operating system 505, for example, may be suitable for controlling computing device 500's operation and, in accordance with an embodiment, may comprise the WINDOWS operating systems from MICROSOFT CORPORATION of Redmond, Wash. It should be understood that the embodiments described herein may also be practiced in conjunction with other operating systems and application programs and further, is not limited to any particular application or system.

The computing device 500 may have additional features or functionality. For example, the computing device 500 may also include additional data storage devices (removable and/or non-removable) such as, for example, magnetic disks, optical disks, solid state storage devices (“SSD”), flash memory or tape. Such additional storage is illustrated in FIG. 5 by a removable storage 509 and a non-removable storage 510.

Generally, consistent with various embodiments, program modules may be provided which include routines, programs, components, data structures, and other types of structures that may perform particular tasks or that may implement particular abstract data types. Moreover, various embodiments may be practiced with other computer system configurations, including hand-held devices, multiprocessor systems, microprocessor-based or programmable consumer electronics, minicomputers, mainframe computers, and the like. Various embodiments may also be practiced in distributed computing environments where tasks are performed by remote processing devices that are linked through a communications network. In a distributed computing environment, program modules may be located in both local and remote memory storage devices.

Furthermore, various embodiments may be practiced in an electrical circuit comprising discrete electronic elements, packaged or integrated electronic chips containing logic gates, a circuit utilizing a microprocessor, or on a single chip containing electronic elements or microprocessors. For example, various embodiments may be practiced via a system-on-a-chip (“SOC”) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may operate via application-specific logic integrated with other components of the computing device/system 500 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

Various embodiments, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. The system memory 504, removable storage 509, and non-removable storage 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 500. Any such computer storage media may be part of the computing device 500. The computing device 500 may also have input device(s) 512 such as a keyboard, a mouse, a pen, a sound input device, a touch input device, etc. Output device(s) 514 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

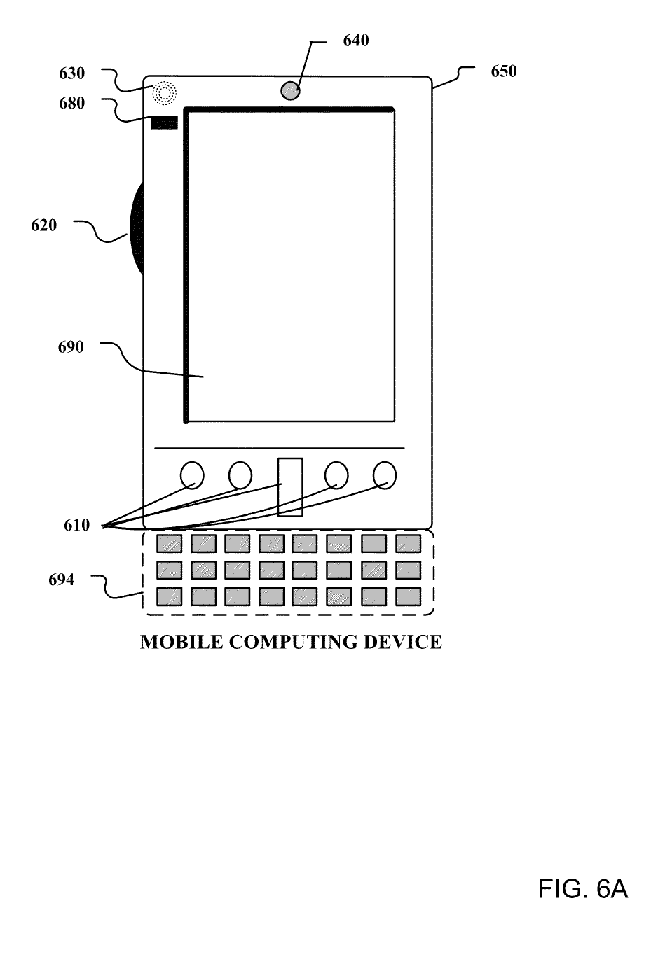

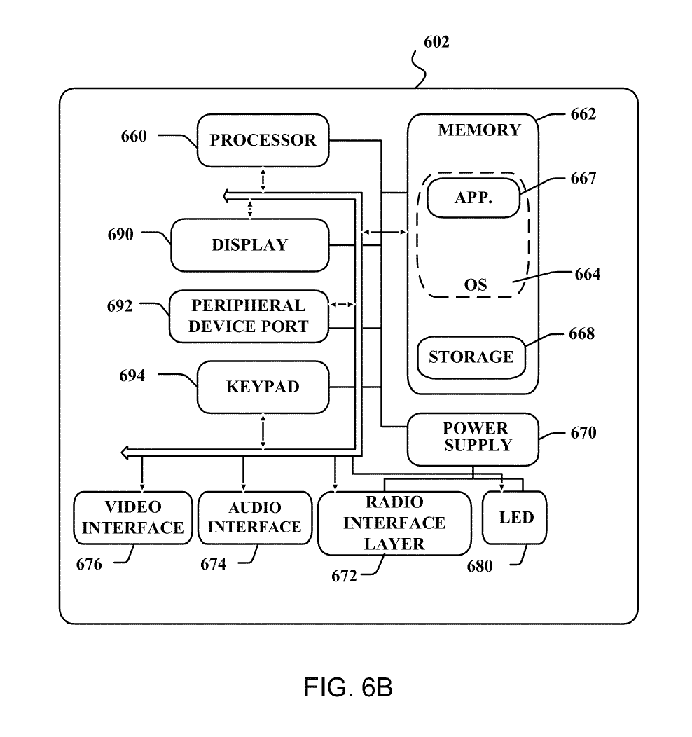

FIGS. 6A and 6B illustrate a suitable mobile computing environment, for example, a mobile computing device 650, a smartphone, a tablet personal computer, a laptop computer, and the like, with which various embodiments may be practiced. With reference to FIG. 6A, an example mobile computing device 650 for implementing the embodiments is illustrated. In a basic configuration, mobile computing device 650 is a handheld computer having both input elements and output elements. Input elements may include touch screen display 625 and input buttons 610 that allow the user to enter information into mobile computing device 650. Mobile computing device 650 may also incorporate an optional side input element 620 allowing further user input. Optional side input element 620 may be a rotary switch, a button, or any other type of manual input element. In alternative embodiments, mobile computing device 650 may incorporate more or less input elements. For example, display 625 may not be a touch screen in some embodiments. In yet another alternative embodiment, the mobile computing device is a portable phone system, such as a cellular phone having display 625 and input buttons 610. Mobile computing device 650 may also include an optional keypad 605. Optional keypad 605 may be a physical keypad or a “soft” keypad generated on the touch screen display.

Mobile computing device 650 incorporates output elements, such as display 625, which can display a graphical user interface (GUI). Other output elements include speaker 630 and LED light 626. Additionally, mobile computing device 650 may incorporate a vibration module (not shown), which causes mobile computing device 650 to vibrate to notify the user of an event. In yet another embodiment, mobile computing device 650 may incorporate a headphone jack (not shown) for providing another means of providing output signals.

Although described herein in combination with mobile computing device 650, in alternative embodiments may be used in combination with any number of computer systems, such as in desktop environments, laptop or notebook computer systems, multiprocessor systems, micro-processor based or programmable consumer electronics, network PCs, mini computers, main frame computers and the like. Various embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate the various embodiments described herein.

FIG. 6B is a block diagram illustrating components of a mobile computing device used in one embodiment, such as the mobile computing device 650 shown in FIG. 5A. That is, mobile computing device 650 can incorporate a system 602 to implement some embodiments. For example, system 602 can be used in implementing a “smart phone” that can run one or more applications similar to those of a desktop or notebook computer. In some embodiments, the system 602 is integrated as a computing device, such as an integrated personal digital assistant (PDA) and wireless phone.

Applications 667 may be loaded into memory 662 and run on or in association with an operating system 664. The system 602 also includes non-volatile storage 668 within memory the 662. Non-volatile storage 668 may be used to store persistent information that should not be lost if system 602 is powered down. The applications 667 may use and store information in the non-volatile storage 668. A synchronization application (not shown) also resides on system 602 and is programmed to interact with a corresponding synchronization application resident on a host computer to keep the information stored in the non-volatile storage 668 synchronized with corresponding information stored at the host computer. As should be appreciated, other applications may also be loaded into the memory 662 and run on the mobile computing device 650.

The system 602 has a power supply 670, which may be implemented as one or more batteries. The power supply 670 might further include an external power source, such as an AC adapter or a powered docking cradle that supplements or recharges the batteries.

The system 602 may also include a radio 672 (i.e., radio interface layer) that performs the function of transmitting and receiving radio frequency communications. The radio 672 facilitates wireless connectivity between the system 602 and the “outside world,” via a communications carrier or service provider. Transmissions to and from the radio 672 are conducted under control of OS 664. In other words, communications received by the radio 672 may be disseminated to the application 667 via OS 664, and vice versa.

The radio 672 allows the system 602 to communicate with other computing devices, such as over a network. The radio 672 is one example of communication media. The embodiment of the system 602 is shown with two types of notification output devices: an LED 680 that can be used to provide visual notifications and an audio interface 674 that can be used with speaker 630 to provide audio notifications. These devices may be directly coupled to the power supply 670 so that when activated, they remain on for a duration dictated by the notification mechanism even though processor 660 and other components might shut down for conserving battery power. The LED 680 may be programmed to remain on indefinitely until the user takes action to indicate the powered-on status of the device. The audio interface 674 is used to provide audible signals to and receive audible signals from the user. For example, in addition to being coupled to speaker 630, the audio interface 674 may also be coupled to a microphone (not shown) to receive audible input, such as to facilitate a telephone conversation. In accordance with embodiments, the microphone may also serve as an audio sensor to facilitate control of notifications. The system 602 may further include a video interface 676 that enables an operation of on-board camera 630 to record still images, video stream, and the like.

A mobile computing device implementing the system 602 may have additional features or functionality. For example, the device may also include additional data storage devices (removable and/or non-removable) such as, magnetic disks, optical disks, or tape. Such additional storage is illustrated in FIG. 6B by storage 668.

Data/information generated or captured by the mobile computing device 650 and stored via the system 602 may be stored locally on the mobile computing device 650, as described above, or the data may be stored on any number of storage media that may be accessed by the device via the radio 672 or via a wired connection between the mobile computing device 650 and a separate computing device associated with the mobile computing device 650, for example, a server computer in a distributed computing network such as the Internet. As should be appreciated such data/information may be accessed via the mobile computing device 650 via the radio 672 or via a distributed computing network. Similarly, such data/information may be readily transferred between computing devices for storage and use according to well-known data/information transfer and storage means, including electronic mail and collaborative data/information sharing systems.

Various embodiments are described above with reference to block diagrams and/or operational illustrations of methods, systems, and computer program products. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

While certain embodiments have been described, other embodiments may exist. Furthermore, although various embodiments have been described as being associated with data stored in memory and other storage mediums, data can also be stored on or read from other types of computer-readable media, such as secondary storage devices (i.e., hard disks, floppy disks, or a CD-ROM), a carrier wave from the Internet, or other forms of RAM or ROM. Further, the disclosed routines' operations may be modified in any manner, including by reordering operations and/or inserting or operations, without departing from the embodiments described herein.

It will be apparent to those skilled in the art that various modifications or variations may be made without departing from the scope or spirit of the embodiments described herein. Other embodiments will be apparent to those skilled in the art from consideration of the specification and practice of the embodiments described herein.

What is claimed is:

1. A method of utilizing dynamic heuristic transitions between local and remote data for displaying electronic communications, comprising:
loading, by a computer, at least one folder associated with the electronic communications;
determining, by the computer, an initial mode for viewing the electronic communications;
displaying, by the computer, the remote data upon determining that the initial mode for viewing the electronic communications is an online mode;
synchronizing, by the computer, the local data and the remote data to update the local data; and
automatically transitioning, by the computer, from displaying the remote data to displaying the local data after the update of the local data.

2. The method of claim 1, wherein determining, by the computer, an initial mode for viewing the electronic communications comprises determining whether a server connection for providing the at least one folder to the computer is online, wherein the determination is based on initial conditions for an optimal mode of operation, the initial conditions comprising at least one of a synchronization state, network latency and network bandwidth.

3. The method of claim 1, wherein determining, by the computer, an initial mode for viewing the electronic communications comprises determining whether a server connection for providing the at least one folder to the computer is offline, wherein the determination is based on initial conditions for an optimal mode of operation, the initial conditions comprising at least one of a synchronization state, network latency and network bandwidth.

4. The method of claim 3, further comprising displaying the local data upon determining that the server connection for providing the at least one folder to the computer is offline.

5. The method of claim 4, further comprising:
determining that the local data is out of date; and
automatically transitioning from displaying the local data to displaying the remote data after a restoration of the server connection for providing the at least one folder to the computer.

6. The method of claim 1, wherein automatically transitioning, by the computer, from displaying the remote data to displaying the local data after the update of the local data comprises automatically transitioning from displaying at least one online table to displaying at least one cached table.

7. The method of claim 1, wherein automatically transitioning, by the computer, from displaying the remote data to displaying the local data after the update of the local data comprises automatically transitioning from displaying one or more of an online item count and an online unread count to displaying at least one or more of a cached item count and a cached unread count in the electronic communications.

8. The method of claim 1, further comprising:
performing an inter-folder action against an online store when displaying an item in the remote data; and
performing an inter-folder action against a local store when displaying an item in the local data.

9. The method of claim 8, wherein performing an inter-folder action against an online store when displaying an item in the remote data and performing an inter-folder action against a local store when displaying an item in the local data comprises performing an action for modifying contents of the at least one folder associated with the electronic communications.

10. A method of utilizing dynamic heuristic transitions between local and remote data for displaying electronic communications, comprising:
loading, by a computer, at least one folder associated with the electronic communications;
retrieving, by the computer, remote data for the at least one folder and a local data for the at least one folder;
determining, by the computer, that local changes are pending for the at least one folder;
determining, by the computer, that the at least one folder is synchronized with an online store;
querying the remote data and the local data for the at least one folder; and
automatically, by the computer, transitioning to a cached view to display the electronic communications upon receiving only the local data in response to the query.

11. The method of claim 10, further comprising automatically transitioning to an online view to display the electronic communications upon receiving only the remote data in response to the query.

12. The method of claim 10, wherein automatically, by the computer, transitioning to a cached view to display the electronic communications upon receiving only the local data in response to the query comprises determining that a timeout has passed for receiving the remote data.

13. The method of claim 11, wherein automatically transitioning to an online view to display the electronic communications upon receiving only the remote data in response to the query comprises determining that a timeout has passed for receiving the local data.

14. The method of claim 10, wherein retrieving, by the computer, remote data for the at least one folder and local data for the at least one folder comprises retrieving one or more tables comprising data for displaying a list of electronic mail messages in the electronic communications.

15. The method of claim 10, wherein retrieving, by the computer, remote data for the at least one folder and local data for the at least one folder comprises retrieving one or more tables comprising data for displaying one or more of an item count and an unread count associated with a list of electronic mail messages content displayed by the electronic communications.

16. A computer-readable storage medium comprising computer executable instructions which, when executed by a computer, will cause the computer to perform a method of utilizing dynamic heuristic transitions between local and remote data for displaying electronic communications, the method comprising:
loading at least one folder associated with the electronic communications;
retrieving remote data for the at least one folder and local data for the at least one folder, the remote and local data comprising data for displaying a list of messages in the electronic communications;
determining that local changes are pending for the at least one folder;
determining that the at least one folder is synchronized with an online store;
querying the remote data and the local data for the at least one folder; and
automatically transitioning to a cached view by reloading the local data to refresh a cached display of the electronic communications upon receiving only the local data in response to the query.

17. The computer-readable storage medium of claim 16, further comprising automatically transitioning to an online view to display the electronic communications upon receiving only the remote data in response to the query.

18. The computer-readable storage medium of claim 16, wherein automatically transitioning to a cached view by reloading the local data to refresh a cached display of the electronic communications upon receiving only data from the local data in response to the query comprises determining that a timeout has passed for receiving the online data.

19. The computer-readable storage medium of claim 17, wherein automatically transitioning to an online view to display the electronic communications upon receiving only the remote data in response to the query comprises determining that a timeout has passed for receiving the local data.

20. The computer-readable storage medium of claim 16, wherein determining that local changes are pending for the at least one folder comprises determining that there are changes in the local data awaiting synchronization with the online store.
